(19) United States
(12) Patent Application Publication
(10) Pub. No.: US 2008/0080174 A1
(43) Pub. Date: Apr. 3, 2008

(54) Solar light for a fence post

(76) Inventor: Xueming Xu, Jiangsu Province (CN)

Correspondence Address: BIRCH STEWART KOLASCH & BIRCH, PO BOX 747, FALLS CHURCH, VA, 22040-0747, US

(21) Appl. No.: 11/882,433

(22) Filed: Aug. 1, 2007

(30) Foreign Application Priority Data
Sep. 30, 2006 (CN) 200620076646.9

(51) Int. Cl. F21L 4/08; F21S 8/00

(52) U.S. Cl. 362/152

(57) ABSTRACT

The invention discloses a solar light for a fence post, comprising: a connecting element, which is designed to be mounted on the top end of the fence post, a LED lamp, fixed on the top of the connecting element, a solar panel, affixed to the outer wall of the connecting element, a rechargeable battery in electric communication with the LED lamp, and charged by the solar panel. The solar light fixes the solar panel from the outer wall of the connecting element, which is simple in structure, enables the light running upwards to get through the top of the light body, and dose not restrict the figuration of the lamp chimney, in this case, the lamp chimney could be in a more good-looking shape.

### FIELD OF THE INVENTION

The field of the invention relates generally to solar light, particularly to solar light for a fence post.

### BACKGROUND

Recently, there has been a vast increase in the use of solar light in many fields, because of its economical, energy saving, easy to install and environment-friendly characteristics, and solar light for a fence post is widely used in fence industry as one kind of these solar lighting. The present solar light for a fence post comprising: a connecting element, which is designed to be mounted on the top end of the fence post, a LED lamp fixed on the top of the connecting element, which is covered by a lamp chimney, a solar panel, affixed on the top of the lamp chimney, a rechargeable battery in electric communication with the LED lamp, and charged by the solar panel, the lamp lightens in the dark under the control of electronic components. In order to absorb much light, the solar panel should be fixed on the top of the lamp chimney, however, this kind of arrangement of the solar panel restricts the shape of the lamp chimney.

### SUMMARY OF THE INVENTION

The object of the invention is to provide a solar light for a fence post with a comparatively simple structure, and the layout of the lamp chimney is not restricted, and with a lower cost of manufacturing.

The technical solution of the invention is a solar light for a fence post, comprising: a connecting element, which is designed to be mounted on the top end of the fence post, at least one LED lamp, fixed on the top of the connecting element, at least one rechargeable battery in electric communication with the LED lamp, and charged by at least one solar panel, the said solar panel is fixed on the outer wall of the connecting element.

The further technical solution of the invention is a solar light for a fence post, comprising: a connecting element, which is designed to be mounted on the top end of the fence post, at least one LED lamp fixed on the top of the connecting element, at least one rechargeable battery in electric communication with the LED lamp, and charged by at least one solar panel, the said solar panel is fixed on the outer wall of the connecting element; the LED lamp is fixed on the top of the connecting element, which is provided With a lamp chimney seat, a lamp chimney is mounted on the lamp chimney seat, and covers the LED lamp, the connecting element contains a shoulder, which is provided with a attachment surface, to which the solar panel is affixed, the electric components and the battery may be equipped within the connecting element.

The advantages of the invention are as follows:

1□The invention transfers the solar panel from the top of the light to the outer wall of the connecting element, which is simple in structure, lowers down the cost of manufacturing, enables the light running upwards to get through the top of the light body.

2. The invention dose not restrict the figuration of the lamp chimney by removing the solar panel from the top, in this case, the lamp chimney could be in a more good-looking shape.

The invention will be further described in combination with drawings and embodiments in the following.

### BRIEF DESCRIPTION OF THE DRAWINGS

FIG. 1 shows, a schematic drawing through one embodiment of the invention.

FIG. 2 shows, an A-A sectional view of FIG. 1.

FIG. 3 shows, a schematic drawing through another embodiment of the invention.

FIG. 4 shows, a B-B sectional view of FIG. 3.

Where: 1. connecting element; 2. solar panel; 3. LED lamp; 4. battery; 5. lamp chimney; 6. lamp chimney seat; 7. shoulder; 71. attachment surface; 8. fence post.

### DETAILED DESCRIPTION OF THE EMBODIMENTS

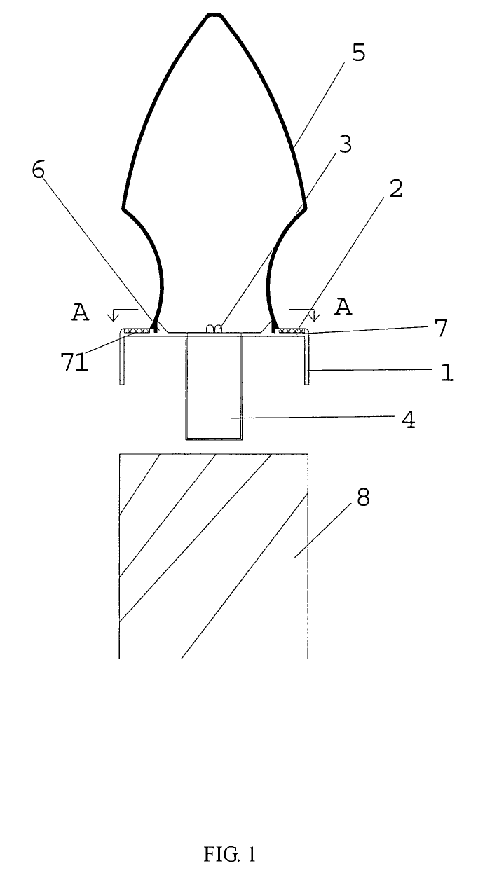

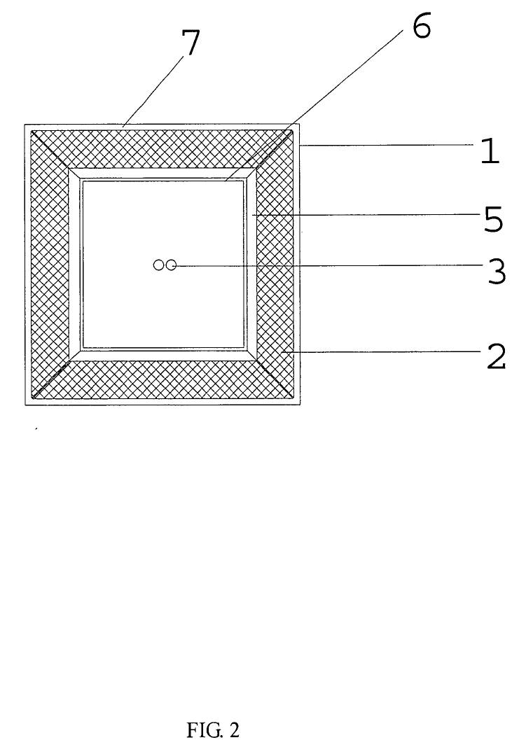

An embodiment in accordance with FIG. 1 and FIG. 2, a solar light for a fence post, comprising: a connecting element 1, which is designed to be mounted on the top end of the fence post 8, two LED lamps 3, fixed on the center of the top of the connecting element 1, the top of the connecting element 1 is provided with a lamp chimney seat 6, surrounding the LED lamp 3, a lamp chimney 5 (which is ball-shaped as FIG. 1 shows) is mounted on the lamp chimney seat 6, and covers the LED lamp 3 to seal the light from moisture and dust.

The lamp chimney seat 6 may be annular, which is smaller than the top of the connecting element 1, and the LED lamp 3 is positioned on the center of the lamp chimney seat 6, in this case, the peripheral region of the lamp chimney scat 6 on the top of the connecting element 1 (can be considered the shoulder 7 of the connecting clement) is provided with a attachment surface 71, to which the solar panel 2 is affixed, a rechargeable battery 4 is equipped on the interior wall of the connecting element 1, in electric communication with the LED lamp 3, and charged by the solar panel 2.

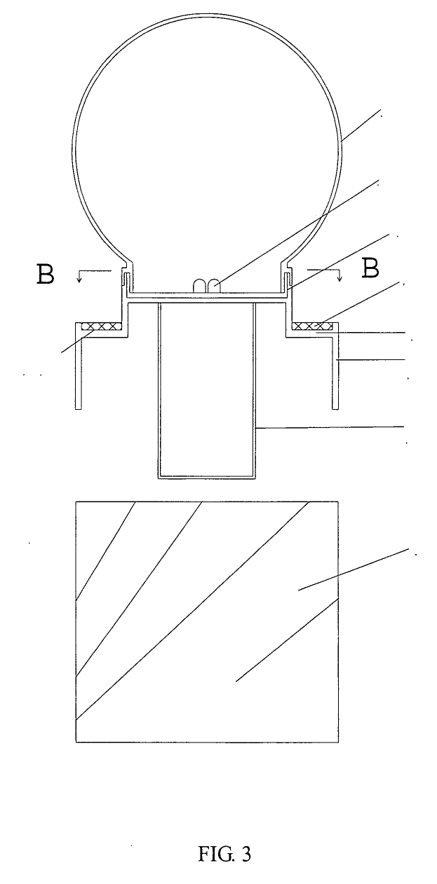

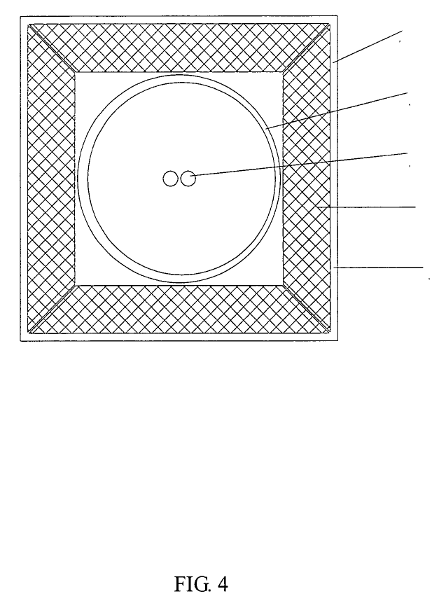

Another embodiment in accordance with FIG. 3 and FIG. 4, a solar light for a fence post, comprising: a connecting element 1, which is designed to be mounted on the top end of the fence post 8, provided with a shoulder 7, containing a attachment surface 71, a LED lamp 3, fixed on the center of the top of the connecting element 1, the connecting element 1 is provided with a lamp chimney seat 6, surrounding the LED lamp 3, a lamp chimney 5 (which is spire-shaped as FIG. 3 shows) is mounted on the lamp chimney seat 6, and covers the LED lamp 3 to seal the light from moisture and dust.

The lamp chimney seat 6 may be quadrate, and the LED lamp 3 is positioned on the center of the lamp chimney seat 6, in this case, the solar panel 2 is affixed to the shoulder, a rechargeable battery 4 is equipped on the interior wall of the connecting element 1, in electric communication with the LED lamp 3, and charged by the solar panel 2.

The lamp lightens in the dark under the control of electronic components, which may be equipped in the interior of the connecting element 1.

The invention transfers the solar panel 2 from the top of the light to the outer wall of the connecting element, which is simple in structure, enables the light running upwards to get through the top of the light body, dose not restrict the figuration of the lamp chimney by removing the solar panel from the top, in this case, the lamp chimney could be in a good-looking shape.

What is claimed:

1. A solar light for a fence post, comprising: a connecting element (1), which is designed to be mounted on the top end of the fence post (8), at least one LED lamp (3) fixed on the top of the connecting element (1), at least one rechargeable battery (4) in electric communication with the LED lamp (3), and charged by at least one solar panel (2), fixed on the outer wall of the connecting element.

2. A solar light for a fence post according to claim 1, wherein said LED lamp (2) is fixed on the top of the connecting element (1), which is provided with a lamp chimney seat (6) mounted with a light-penetrable lamp chimney (5), the lamp chimney (5) covers the LED lamp (3), the connecting element (1) is provided with a shoulder (7), which contains at least one attaching surface (71), to which the solar panel (2) is affixed.
